(19) United States
(12) Patent Application Publication
(10) Pub. No.: US 2005/0140792 A1
(43) Pub. Date: Jun. 30, 2005

(54) Camera with adjustable focus

(76) Inventor: Markus Hermsen, Grobenzell (DE)

Correspondence Address: BELL, BOYD & LLOYD, LLC, P. O. BOX 1135, CHICAGO, IL, 60690-1135, US

(21) Appl. No.: 10/501,680

(22) PCT Filed: Jan. 2, 2003
(86) PCT No.: PCT/DE03/00005

(30) Foreign Application Priority Data
Jan. 18, 2002 (DE) 102 01 877.4

(51) Int. Cl. H04N 5/225

(52) U.S. Cl. 348/208.12

(57) ABSTRACT

The present disclosure relates to a camera apparatus comprising a housing, a lens, a sensor acting as a focal plane, a piezo-element to displace the sensor, said piezo-element positioned to touch the sensor and connectors to make contact with the sensors. According to the disclosure, the lens is fixedly mounted to the housing. In a preferred embodiment, the focal plane is displaced by the piezo-element to adjust the focus.

### BACKGROUND

The present disclosure relates to a camera which can be used in mobile terminals such as, for example, mobile radio devices.

Miniaturized cameras are needed for mobile terminals, such as, for example, third-generation mobile radio devices.

Known cameras are equipped with an adjustable lens. An adjustable lens requires a complex, mechanical adjustment mechanism. Such mechanical devices are, however, cost-intensive, relatively large and susceptible to mechanical effects such as shock, dust, and wear.

A disadvantage with currently manufactured focused cameras (fixed-focus systems) is that it is cost-intensive to focus the lens during assembly of the camera. Therefore it is problematic to mass produce such cameras while delivering quality, in a cost effective manner.

Furthermore, the use of autofocus controls is known for cameras in which the lens is moved for focusing electrically, magnetically or by a motor. Such controls are, however, susceptible to faults, are not stable, need a great deal of energy and take up a lot of space. As such, it is problematic to provide miniature size cameras incorporating such controls. Therefore it is desirable to integrate autofocus functionality into cameras.

### SUMMARY

The present disclosure relates to a camera, which can be embodied as a miniature design having low power consumption and that is not susceptible to mechanical effects. Furthermore, the disclosed camera allows for a hermetically dust-proof construction, at a low overall cost. In addition, the camera can be integrated into a housing that offers sufficient protection against environmental effects for use, for example, in mobile terminals.

The camera apparatus includes a housing, a lens, a sensor as its focal plane, a piezo element for displacing the sensor, and connecting elements for making contact with the sensor. The piezo element is configured and arranged below the sensor, and the lens is mounted in the camera in a fixed way, preferably in the camera housing.

In a preferred embodiment, the focal plane is displaced by the piezo element for focusing. In contrast with known focusing arrangements, the camera is not focused by moving the lens. The lens can be fixed to the camera housing, thereby greatly reducing the risk of outside influences being able to affect the lens. As such, the housing protects the camera from environmental effects. Such environmental effects include, for example, moisture, dust, aerosols, wind, radiation, electrostatic discharges or mechanical shocks.

The presently disclosed apparatus uses the reciprocal piezo effect of the piezo element for focusing. When a voltage is applied to a piezoelectric material, the material is mechanically deformed. The piezo element is a piezoelectric material, and is arranged below the sensor. Applying voltage, to cause mechanical deformation of the piezo element, thereby enables the sensor lying on the piezo element, i.e., the focal plane, to be moved in parallel to the lens. As such, focusing can be controlled by moving the focal plane, which depends on the voltage applied.

The presently disclosed apparatus utilizes a piezo element that can be used to move the focal plane, since a movement of only a few 10 μm, e.g. ±50 μm, is required for focusing. Consequently, in an embodiment, a piezo element of known reliability, precision, and stability is used. Because piezo elements consume relatively little current, and only consume current when the voltage applied to them is changed, at a constant voltage, practically no current is consumed. The main power consumption is through loss of energy from the current converter. Therefore, in an embodiment, piezo elements are used for mobile applications.

In another embodiment, the connecting elements for making contact with the sensor include cables, wires or bond wires. In particular, wire bonding connections are used to provide a connection between the sensor and a circuit board or a flexible circuit board or flex foil.

In accordance with the present disclosure, the connecting elements are configured and arranged in such a way that it is possible to move the sensor in parallel to the lens. Contact is made with the sensor in this case on two opposite sides using the bond wires.

The connecting wire is preferably bonded to the sensor. Other connecting options, such as a direct connection of flexible leads between the sensor and the circuit board or connecting flex can be provided including bonding, gluing or the like. The bond wires preferably have so much free play that a maximum deformation of the piezo element is not restricted by the cable, and a sufficiently long life of the bond connection remains guaranteed with an active piezo element.

In another embodiment, the connecting elements are configured and arranged as at least one flex foil. Preferably, the flex foil consists of a Polyamide substrate with a copper foil cladding and an isolation layer of Polyamide as a covering layer.

In addition, in a preferred embodiment, the flex foil is a thin design with a thickness of less than 34 μm.

In yet another embodiment, the sensor is configured and arranged on the connecting elements.

In a further embodiment of the present disclosure, the connecting elements (e.g., a flex foil) feature two elliptical cutouts and are fixed to the camera housing at the edge, arranged over the piezo element in the connecting area with the sensor. Utilizing flex foil as the connecting elements allows stable contact to be made with the sensor at a low cost. In addition, optimum functionality of the camera is guaranteed even after a large number of focusing cycles.

In a further embodiment of the present disclosure the camera apparatus features an infrared filter.

Further the camera apparatus can feature a protective glass cover over the lens.

In a further embodiment of the present disclosure the camera apparatus is combined with an autofocus control. Thus, autofocusing is possible for such miniaturized cameras. This is accomplished by using a corresponding algorithm that takes over the control of the piezo element. Such an algorithm can, for example, be integrated into an image processor of the camera.

Additional features and advantages of the present invention are described in, and will be apparent from, the following Detailed Description and the figures.

### BRIEF DESCRIPTION OF THE DRAWINGS

FIG. 1 is a schematic diagram of a camera apparatus in accordance with the present disclosure, including connecting bond wires;

FIG. 2 is a schematic diagram of a camera apparatus in accordance with the present disclosure including a flexible connection as the connecting element.

FIG. 3 is a diagram of a flex foil for use with the camera of FIG. 2.

### DETAILED DESCRIPTION OF THE PRESENT EXAMPLES

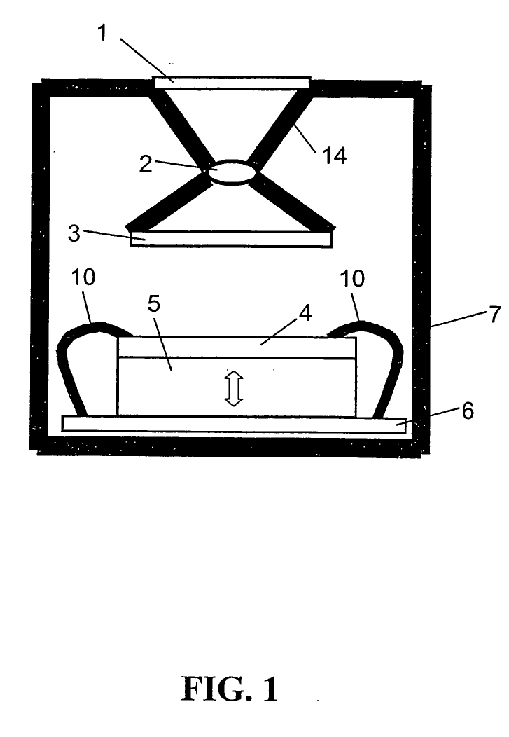

Referring to FIG. 1, an embodiment of a camera apparatus is illustrated. The camera features a protective glass cover 1, a focusing lens 2 and an infrared filter 3. The lens 2 is fixed to the housing 7 with a frame 14. The lens 2 cannot be moved. A sensor 4 represents the focal plane. A piezo element 5, which is located on a circuit board 6, is arranged below the lens. With the aid of the bond wires 10, a connection is provided between the sensor 4, and the circuit board 6. The application of a voltage (not shown) to the piezo element deforms the latter in a vertical direction (as indicated by the arrow) so that the sensor 4 lying on it, i.e., the focal plane of the camera, rises or falls. The camera can thus be focused by changing the voltage applied to the piezo element 5. The wires 10 can be bonded to the sensor 4.

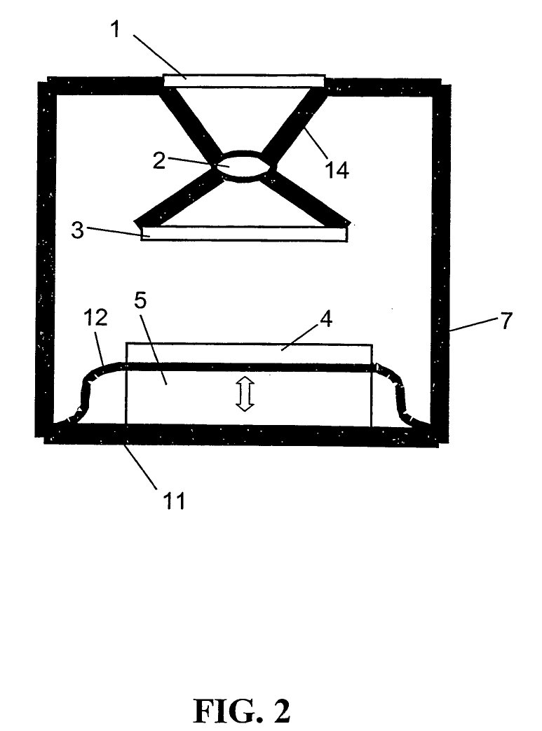

FIG. 2 shows another embodiment of the presently disclosed camera apparatus. The camera apparatus of FIG. 2 again includes a protective glass cover 1, a focusing lens 2 and an infrared filter 3. The lens 2 is again fixed to the housing 7 via frame 14. Contact with sensor 4 is made using a thin flex foil 12. The sensor 4 is on the flex foil 12 in this case. By applying a voltage (not shown) to the piezo element 5, the sensor 4 on the flex foil 12, i.e., the focal plane of the camera, can be raised or lowered. The camera can thus be focused depending on the voltage applied to the piezo element 5.

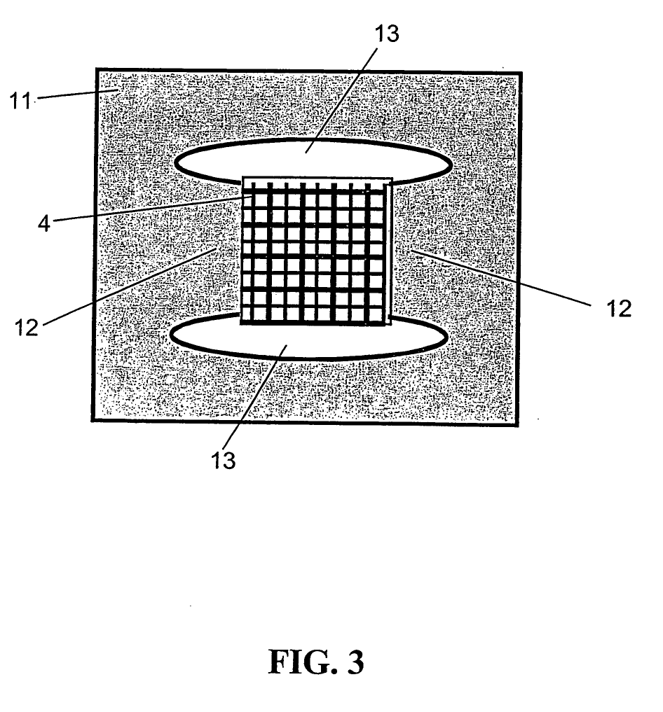

FIG. 3 shows a plan view of a layout of a flex foil in accordance with the embodiment of FIG. 2. The sensor 4 lies in the central area of the flex foil 11 on the foil. The flex foil 11 features two elliptical cutouts 13. The piezo element (not visible in FIG. 3) is located in the area of connecting ends 12 of the flex foil 11, i.e., under the sensor 4. In the edge area of flex foil 11, i.e., around the cutouts 13, the flex foil 11 is connected with the underside of the housing 7 (not shown). The elliptical shape of the cutouts 13 is exemplary and not mandatory.

In all embodiments it is conceivable to omit the protective glass covers above the lens and, depending on the system, also the infrared blocking filter.

The present disclosure also provides adjustable focus in a camera largely protected from environmental effects. Known miniature cameras can therefore be kept the same size, but the field of application for such cameras is increased.

In addition, the present disclosure relates to the assembly of such camera apparatus, since no small precise fine adjustment tolerances are needed for arranging the lens and only a relatively rough adjustment of the lens is required. The camera can also be focused correctly manually by the user. This has a significant influence on the manufacturing costs of such a camera in series production.

Furthermore, temperature compensation of the focus adjustment can be implemented with such a system. As conventional camera constructions must take account of the effects of the different working temperatures in the construction of the housing, and because this can only be done to a limited extent, or at significant expense, the costs of a camera module can be reduced.

The presently disclosed apparatus can be combined with any type of autofocus control, so that autofocus functionality is provided. Better protection against dust is possible by comparison with known autofocus concepts.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. Miniaturized camera with a housing (7) featuring:
a lens (2);
a sensor (4) as a picture element;
a piezo element (5) for displacing the sensor, in which case the piezo element is arranged below the sensor;
connecting elements (10, 11, 12) for making contact with the sensor,
characterized in that the lens (2) is mounted in a fixed manner in the camera, especially in the camera housing, and the connecting elements are embodied as at least one flex foil (11, 12) and feature two cutouts (13).

2. Camera in accordance with claim 1,
characterized in that the focal plane is displaced by the piezo element for focusing.

3. Camera in accordance with one of the previous claims,
characterized in that the connecting elements are embodied as cables, wires or bond wires (3).

4. Camera in accordance with claim 3,
characterized in that the connecting elements provide a connection between the sensor and a circuit board or a flexible circuit board, especially a flex foil, (6).

5. Camera in accordance with one of the claims 3 or 4,
characterized in that the connecting elements are embodied so that it is possible to move the sensor in parallel to the lens.

6. Camera in accordance with claim 1 or 2,
characterized in that the flex foil is a thin design.

7. Camera in accordance with one of the claims 1, 2 or 6,
characterized in that the sensor is arranged on the connecting elements.

8. Camera in accordance with claim 1, 2, 6 or 7
characterized in that cutouts (12) are embodied as elliptical shapes.

9. Camera in accordance with one of the claims 1, 2 or 6 to 8,
characterized in that the connecting elements are attached in the edge area to the housing of the camera.

10. Camera in accordance with one of the claims 1, 2, or 6 to 9,
characterized in that the connecting elements are arranged in the connecting area with the sensor (10) over the piezo element.

11. Camera in accordance with one of the claims 1, 2, or 6 to 10,
characterized in that the connecting elements are embodied so that it is possible to move the sensor in parallel to the lens.

12. Camera in accordance with one of the previous claims,
characterized in that the camera features an infrared filter (3).

13. Camera in accordance with one of the previous claims,
characterized in that the camera features a protective glass cover (1) over the lens.

14. Camera in accordance with one of the previous claims,
characterized in that the housing (7) protects the camera against environmental effects.

15. Camera in accordance with one of the previous claims
characterized in that the camera is combined with an autofocus control.
